(19) United States
(12) Patent Application Publication
(10) Pub. No.: US 2016/0112145 A1
(43) Pub. Date: Apr. 21, 2016

(54) RADAR DETECTION FOR WIRELESS COMMUNICATIONS

(71) Applicant: Qualcomm Incorporated, San Diego, CA (US)

(72) Inventors: Meriam Khufu Ragheb Rezk, Campbell, CA (US); Srinivas Jasti, Santa Clara, CA (US)

(21) Appl. No.: 14/518,897

(22) Filed: Oct. 20, 2014

(51) Int. Cl. H04B 15/00; H04B 11/00; H04W 24/08

(52) U.S. Cl. CPC H04B 15/00; H04W 24/08; H04B 11/00

(57) ABSTRACT

A method and apparatus are disclosed for searching for a radar signal within signals received by a wireless device. The wireless device may receive signals within a first frequency segment and a second frequency segment. The first frequency segment and the second frequency segment may be non-contiguous. The wireless device may determine energy within the first frequency segment and the second frequency segment and may detect a strong signal event with the first and/or the second frequency segments. In response to detecting the strong signal event, the wireless may search for the radar signal based, at least in part, on the determined energy within the first frequency segment and the second frequency segment and the strong signal event.

### TECHNICAL FIELD

The present embodiments relate generally to wireless communications, and specifically to detecting radar signals within operating frequencies used for wireless communications.

### BACKGROUND OF RELATED ART

Wireless devices may share operating frequencies with radar devices within the 5 GHz frequency band. Portions of the shared 5 GHz frequency band may be referred to as a Dynamic Frequency Selection (DFS) frequency band. A wireless device may follow DFS protocols to vacate operations within portions of the shared frequency band when a radar signal, possibly from a radar device, is detected. Detecting radar signals may be difficult when the wireless device uses non-contiguous frequency bands for wireless communications. For example, the wireless device may transmit signals through a communication channel that includes a first frequency segment and a second, non-contiguous frequency segment. In some implementations, the first frequency segment may be adjacent to the second frequency segment. In some other implementations, only the second frequency segment may be within a DFS frequency band. A radar signal may be detected within the first segment while an aliased image of the radar signal may be detected within the second frequency segment. The aliased image of the radar signal in the second frequency segment may trigger a false radar detection that may cause the wireless device to unnecessarily cease (vacate) operations.

Thus, there is a need to improve radar signal detection in frequency bands shared between radar devices and wireless devices.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

A method of searching for a radar signal by a wireless device is disclosed. In accordance with the present embodiments, signals may be received by the wireless device within a first frequency segment and a second frequency segment. The wireless device may determine energy associated with the received signals and detect a strong signal event based, at least in part, on the received signals. The wireless device may search for the radar signal based, at least in part, on the determined energy and the strong signal event.

For some embodiments, the wireless device may include a transceiver to transmit and receive communication signals through a communication channel; a processor; and a memory storing instructions that, when executed by the processor, cause the wireless device to: receive signals within a first frequency segment and a second frequency segment; determine energy associated with the received signals within the first frequency segment and the second frequency segment; detect a strong signal event based, at least in part, on the received signals; and search for a radar signal based, at least in part, on the determined energy and the strong signal event.

### BRIEF DESCRIPTION OF THE DRAWINGS

The present embodiments are illustrated by way of example and are not intended to be limited by the figures of the accompanying drawings. Like numbers reference like elements throughout the drawings and specification.

FIG. 1 depicts an example communication system within which the present embodiments may be implemented.

FIG. 2 shows a block diagram of a receiver, in accordance with some embodiments.

FIG. 3 shows a wireless device that is one embodiment of the wireless devices depicted in FIG. 1.

FIG. 4 shows an illustrative flow chart depicting an example operation for searching for a radar signal in accordance with some embodiments.

FIGS. 5A and 5B show an illustrative flow chart depicting another example operation for searching for a radar signal in accordance with some embodiments.

### DETAILED DESCRIPTION

The present embodiments are described below in the context of Wi-Fi enabled devices for simplicity only. It is to be understood that the present embodiments are equally applicable for devices using signals of other various wireless standards or protocols. As used herein, the terms “wireless local area network (WLAN)” and “Wi-Fi” can include communications governed by the IEEE 802.11 standards (including standards describing multiple input/multiple output communications), BLUETOOTH®, HiperLAN (a set of wireless standards, comparable to the IEEE 802.11 standards, used primarily in Europe), and other technologies used in wireless communications. Further, the terms “low-power state” refer to a low-power operating mode in which one or more components of a Wi-Fi device or station are deactivated (e.g., to prolong battery life).

In the following description, numerous specific details are set forth such as examples of specific components, circuits, and processes to provide a thorough understanding of the present disclosure. The term “coupled” as used herein means coupled directly to or coupled through one or more intervening components or circuits. Also, in the following description and for purposes of explanation, specific nomenclature is set forth to provide a thorough understanding of the present embodiments. However, it will be apparent to one skilled in the art that these specific details may not be required to practice the present embodiments. In other instances, well-known circuits and devices are shown in block diagram form to avoid obscuring the present disclosure. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components. The present embodiments are not to be construed as limited to specific examples described herein but rather to include within their scope all embodiments defined by the appended claims.

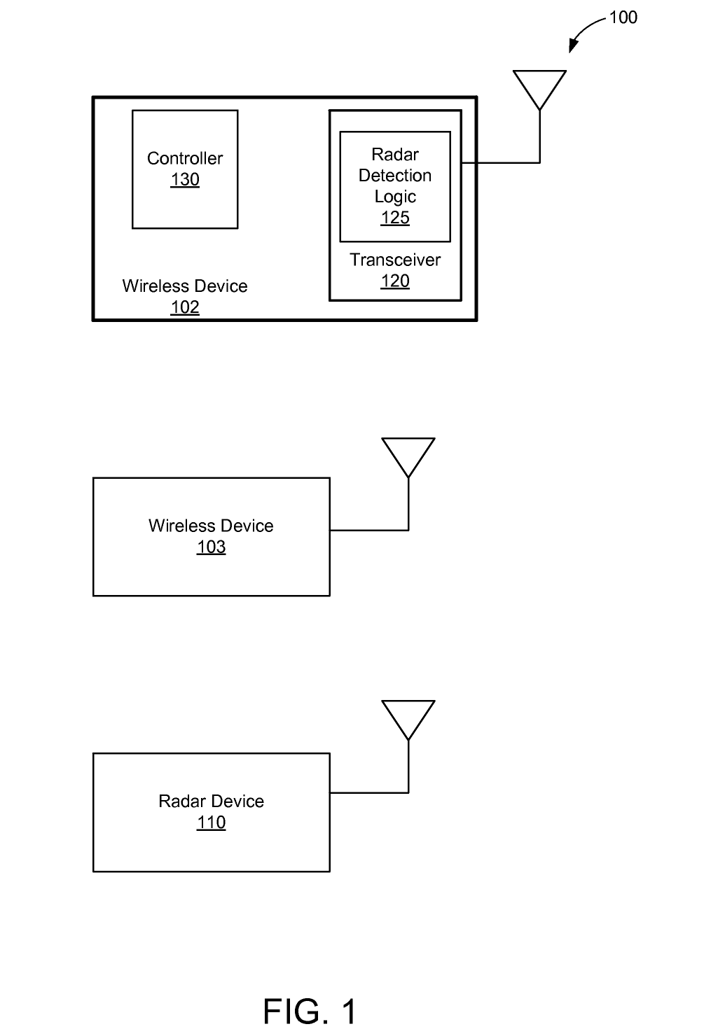

FIG. 1 depicts an example communication system 100 within which the present embodiments may be implemented. Communication system 100 includes wireless devices 102 and 103, and radar device 110. Wireless devices 102 and 103 may be any suitable Wi-Fi enabled device including, for example, a cell phone, laptop, tablet computer, wireless access point, or the like. Although only two wireless devices 102 and 103 are shown in FIG. 1 for simplicity, it is to be understood that the communication system 100 may include any number of wireless devices. Similarly, although only one radar device 110 is shown, the communication system 100 may include any number of radar devices.

Wireless devices 102 and 103 may establish a communication channel within a frequency band to transmit and receive communication signals. The communication channel may be described by an operational mode. In some embodiments, the operational mode may be described by the IEEE 802.11 ac draft specification and may correspond to a bandwidth used by wireless devices 102 and 103. For example, a first operational mode may use 20 MHz of bandwidth, while a second operational mode may use 40 MHz of bandwidth. Additionally, wireless devices 102 and 103 may operate in 80 MHz and 160 MHz operational modes. In some embodiments, the operational mode may specify two or more non-contiguous frequency segments. For example, in some 160 MHz operational modes, an 80 MHz frequency segment may be separated from another 80 MHz frequency segment by a predetermined frequency band. Other operational modes (e.g., 80 MHz and 40 MHz operational modes) may also support two or more non-contiguous frequency segments. In some embodiments, such as when two non-contiguous frequency segments are used, a first frequency segment may be referred to as a primary segment and a second frequency segment may be referred to as an extension segment.

The communication channel may wholly or partially be included within a DFS frequency band. Wireless devices 102 and 103 may detect radar signals associated with (emanating from) radar device 110 within the communication channel. Regulatory agencies have specified that when a wireless device detects a radar signal within a communication channel shared with a DFS frequency band, the wireless device ceases operations within the communication channel. For example, if a radar signal is detected by wireless device 102 within a frequency segment shared with a DFS frequency band, then operations by the wireless device within the communication channel may be terminated for a predetermined amount of time. In some embodiments, operations may not be resumed until a subsequent check for the radar signal is performed and no radar signals are detected within the communication channel.

In some embodiments, a wireless device (e.g., wireless device 102 or 103) may operate within a communication channel that is partially within a DFS frequency band. If the wireless device detects a radar signal within a DFS portion of the communication channel, the wireless device may vacate operations within the DFS portion, and maintain operations within the non-DFS portion. As a result, the communication channel bandwidth may be reduced.

Wireless device 102 may include transceiver 120 to transmit and receive communication signals through the communication channel. The transceiver 120 may also include radar detection logic 125 to detect radar signals within frequency segments used by wireless device 102. Wireless device 102 may also include controller 130 to control operations of wireless device 102 and/or transceiver 120. For example, controller 130 may select an operational mode and provide data to transceiver 120. Controller 130 may determine that a radar signal is present within the communication channel via radar detection logic 125 and may stop transmitting communication signals. Although not shown for simplicity, wireless device 103 may also include a transceiver and a controller similar to transceiver 120 and controller 130.

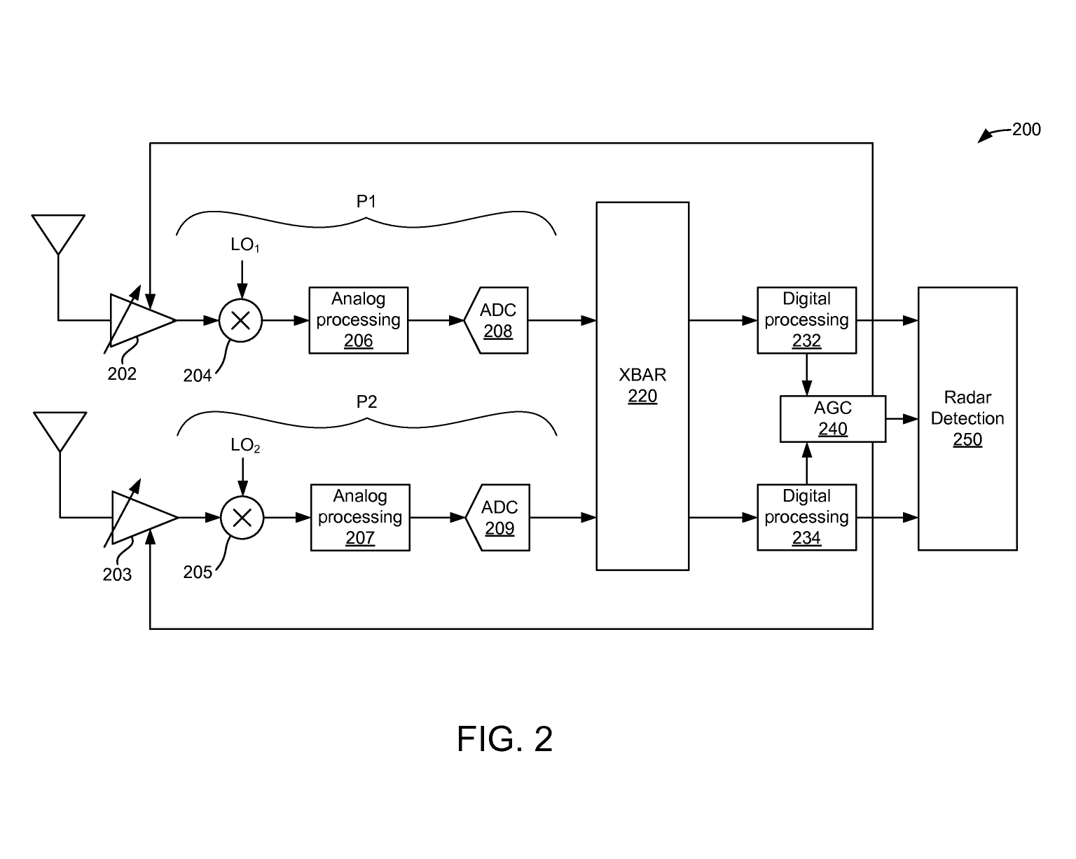

FIG. 2 shows a block diagram of a receiver 200, in accordance with some embodiments. In some embodiments, receiver 200 may be included in transceiver 120 of FIG. 1 to receive communication signals. Receiver 200 includes a first analog processing path (P1) to receive a first frequency segment. The first analog processing path P1 may include a low noise amplifier (LNA) 202, mixer 204, analog processing block 206, and analog-to-digital converter (ADC) 208. LNA 202 may receive and amplify a signal, such as a communication signal and/or a radar signal. Mixer 204 may “mix” together (e.g., multiply together and generate a signal based on a product of two input signals) the amplified signal from LNA 202 and a first local oscillator signal (LO₁). The output of mixer 204 may be coupled to analog processing block 206. Analog processing block 206 may include filters and other amplifiers (not shown for simplicity) to further process the output signal provided by mixer 204. Analog processing block 206 may be coupled to ADC 208. ADC 208 may generate a digital signal based on the output signal generated by analog processing block 206.

As described above, some operational modes may not use a contiguous frequency band. In some embodiments, a second analog processing path (P2) may be included in receiver 200 to receive communication signals in a second (and possibly non-contiguous) frequency segment. Thus, receiver 200 may include LNA 203, mixer 205, analog processing block 207, and ADC 209 to implement the second analog processing path P2. The second analog processing path P2 may include a second local oscillator signal (LO₂). In some embodiments, an LNA (not shown for simplicity) may be shared between the first and the second analog processing paths. The first frequency segment may be separated from the second frequency segment by any feasible frequency band. For example, the first frequency segment and the second segment may be separated by 80 MHz. In another example, a frequency segment may include a band of non-operational frequencies (e.g., frequencies where no wireless communications are permitted). For example, if a 5 MHz frequency band of non-operational frequencies is included with a 160 MHz wide communication channel, then the first or the second frequency segment may be extended to accommodate the 5 MHz frequency band of non-operational frequencies. In some embodiments, the first frequency segment and the second frequency segment may be processed individually by the first analog processing path P1 and the second analog processing path P2, respectively, but may be adjacent (in frequency) to each other. For example, the first frequency segment may not be separated by a frequency band from the second frequency segment.

Although not shown for simplicity, the first and the second analog processing paths P1 and P2 may also process quadrature signals. In other words, each analog processing path P1 and P2 may include two separate paths based on a local oscillator signal including an in-phase portion and a quadrature portion approximately 90 degrees offset from the in-phase portion. Although only two analog processing paths P1 and P2 are depicted in FIG. 2 for simplicity, other embodiments may include any number of analog processing paths.

Output signals from ADCs 208 and 209 may be provided to crossbar (XBAR) 220. XBAR 220 may couple ADCs 208 and 209 to digital processing blocks 232 and 234. For example, XBAR 220 may couple ADC 208 to either digital processing block 232 or 234. Similarly, XBAR 220 may couple ADC 209 to either digital processing block 232 or 234. In some embodiments, receiver 200 may be implemented as two separate units or integrated circuits. For example, a first unit may include LNAs 202 and 203, mixers 204 and 205, analog processing blocks 206 and 207, and ADCs 208 and 209. A second unit may include digital processing blocks 232 and 234 and an automatic gain controller (AGC) 240. The first unit may be coupled to the second unit through XBAR 220.

Digital processing blocks 232 and 234 may provide digital processing functions such as digital filters and/or Fast Fourier Transforms (FFT) to signals provided from the ADCs 208 and 209, respectively. Digital processing blocks 232 and 234 may also be coupled to AGC 240. AGC 240 may adjust gain settings for LNA 202 and 203 based, at least in part, on signals from ADC 208 and/or 209. In some embodiments, AGC 240 may adjust processing gain of mixers 204 and 205, and analog processing blocks 206 and 207. Although only two digital processing blocks 232 and 234 are shown in FIG. 2 for simplicity, other embodiments may include any number of digital processing blocks.

Radar detection block 250 may be coupled to digital processing blocks 232 and 234 and AGC 240. Radar detection block 250 may detect radar signals within frequency segments used within the communication channel by receiver 200.

In one embodiment, a search for a radar signal may be triggered when radar detection block 250 detects a strong signal event within the communication channel. A strong signal event may indicate the presence of a radar signal and may include an indication of a saturated LNA 202 and/or 203, saturation within analog processing blocks 206 and/or 207, saturation of ADCs 208 and/or 209, and/or relatively high power levels at the ADCs 208 and/or 209. Generally, saturation occurs when an input signal to a block or device is of such a magnitude that its output signals do not have a one-to-one correspondence with the input signal. Thus, LNAs 202 or 203 may be saturated when a strong input signal overwhelms the LNA and causes the associated output signal to distort. Similarly, a baseband saturation event may occur when a strong signal is processed in the analog processing block 206 or 207 and results in a distorted output signal. ADC 208 or 209 may saturate when a strong signal is coupled from analog processing blocks 206 or 207, respectively, causing associated ADC output signals to distort. In a similar manner, relatively high ADC power levels (e.g., ADC output levels greater than a threshold) may indicate the presence of a strong signal at inputs of the ADCs 208/209. In another embodiment, radar detection block 250 may use a rising edge detection mechanism to trigger the search for the radar signal. For example, the rising edge detection mechanism may detect an increase of energy and/or signal as well as saturation events within LNA 202 and/or 203, ADC 208 and/or 209, and analog processing blocks 206 and/or 207.

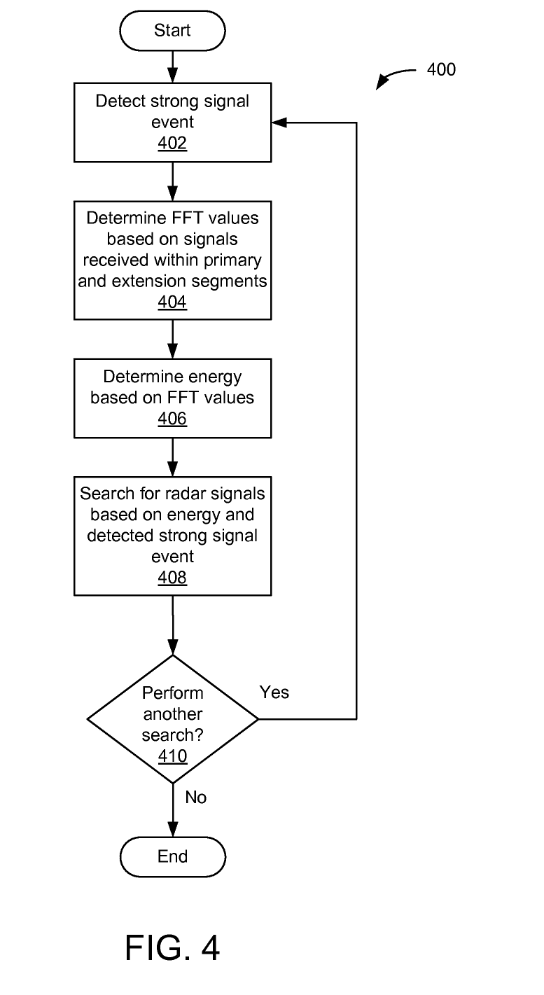

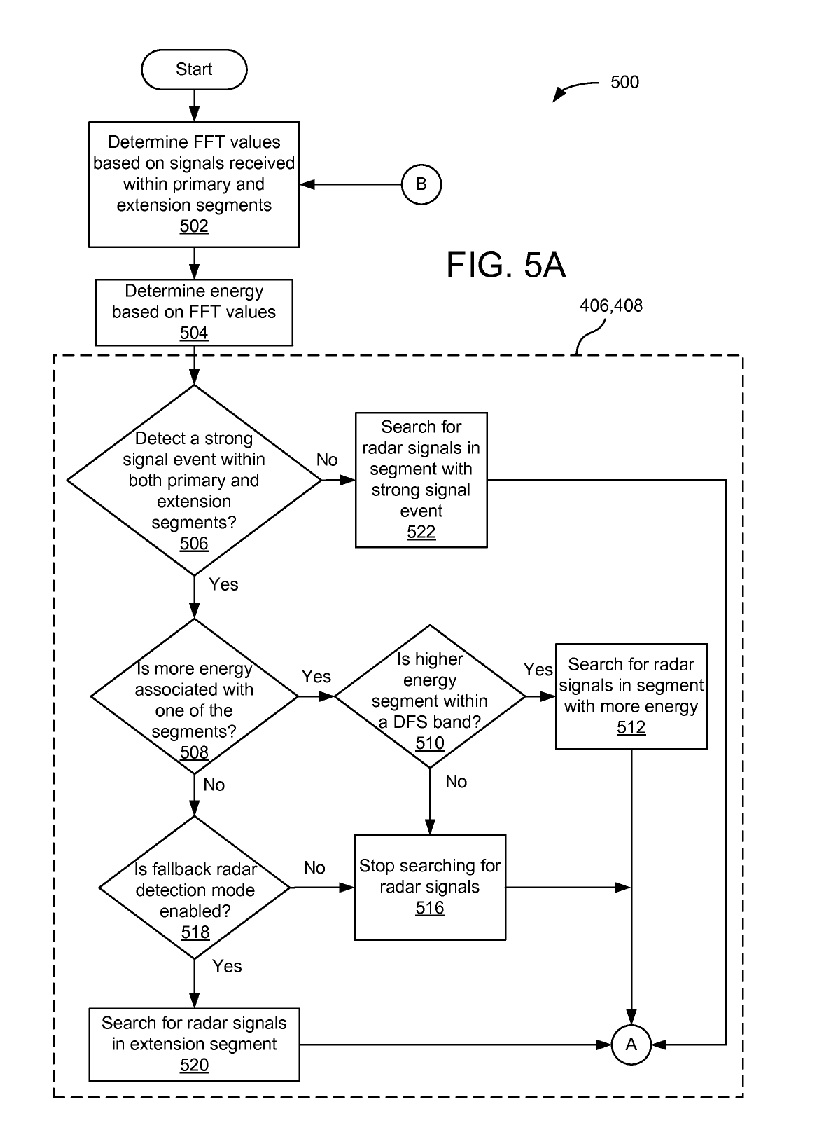

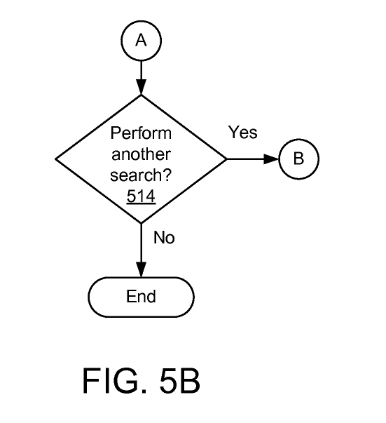

Upon detecting the strong signal event, radar detection block 250 may determine which of analog processing paths P1 and P2, and therefore which associated frequency segment, may include the strong signal event. In some embodiments, the strong signal event may be detected in more than one of analog processing paths P1 and P2. Radar detection block 250 may search for the radar signal in a particular frequency segment based, at least in part, on the analog processing path in which the strong signal event is detected This is described in more detail in conjunction with FIG. 4 and FIGS. 5A and 5B.

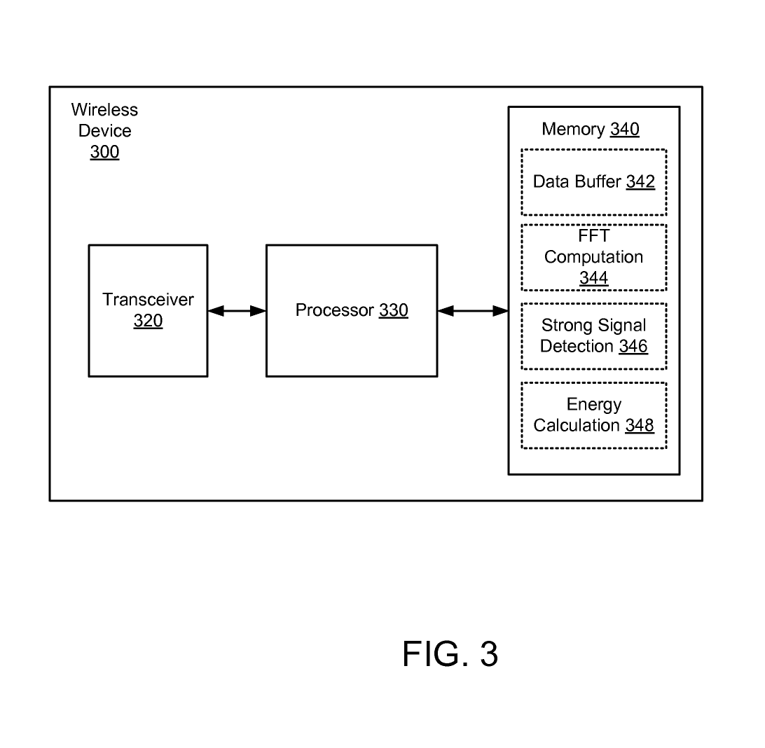

FIG. 3 shows a wireless device 300 that is one embodiment of wireless devices 102 and/or 103 of FIG. 1. The wireless device 300 includes transceiver 320, processor 330, and memory 340. Transceiver 320 may receive and transmit signals and communicate with other wireless devices through the communication channel. In some embodiments, transceiver 320 may include some or all of the elements in transceiver 120 or receiver 200 as described in FIGS. 1 and 2. For example, transceiver 320 may include a digital processing block that may compute FFT values based on signals received through one or more LNAs (digital processing block and LNAs not shown in FIG. 3 for simplicity).

Memory 340 may include data buffer 342 that may be used to cache data from transceiver 320. In some embodiments, data buffer 342 may be shared with analog processing paths P1 and P2 shown in FIG. 2. For example, data from ADC 208 and/or ADC 209 (not shown here for simplicity) may be stored in data buffer 342.

Further, memory 340 may also include a non-transitory computer-readable storage medium (e.g., one or more nonvolatile memory elements, such as EPROM, EEPROM, Flash memory, a hard drive, etc.) that may store the following software modules:
a FFT computation module 344 to compute FFT values;
a strong signal detection module 346 to detect strong signal events within frequency segments used by wireless device 300; and
an energy calculation module 348 to determine an amount of energy associated with the received signal based, at least in part, on FFT values.

Each software module includes program instructions that, when executed by processor 330, may cause wireless device 300 to perform the corresponding function(s). Thus, the non-transitory computer-readable storage medium of memory 340 may include instructions for performing all or a portion of the operations of FIGS. 4, 5A, and/or 5B.

Processor 330, which is coupled to transceiver 320 and memory 340, may be any suitable processor capable of executing scripts or instructions of one or more software programs stored in the wireless device 300 (e.g., within memory 340).

Processor 330 may execute FFT computation module 344 to compute FFT values based on signals received within frequency segments determined by operational modes used by wireless device 300. For example, processor 330 may read data from the ADCs 208 and/or 209 stored in data buffer 342, compute FFT values based on the ADC data, and store the FFT values in data buffer 342.

Processor 330 may execute strong signal detection module 346 to determine when a strong signal event has been detected. In some embodiments, executing the strong signal detection module 346 may monitor LNAs 202 and/or 203 for saturation events, monitor analog processing blocks 206 and/or 207 for baseband saturation events, and/or monitor output signals from ADC 208 and/or 209 for saturation events that may indicate a strong signal has been received by wireless device 300. Additionally, strong signal detection module 346 may determine an output power from the output signals from ADC 208 and/or 209 to detect a strong signal event.

Processor 330 may execute energy calculation module 348 to determine energy associated with the received signal. In some embodiments, the energy calculation module 348 determines energy based on FFT values provided from FFT computation module 344. In other embodiments, energy calculation module 348 may determine a ratio of in-band energy to out-of-band energy. Energy calculation is described in more detail below in conjunction with FIGS. 4, 5A, and 5B.

FIG. 4 shows an illustrative flow chart depicting an example operation 400 for searching for a radar signal in accordance with some embodiments. Some embodiments may perform the operations described herein with additional operations, fewer operations, operations in a different order, operations in parallel, and/or some operations differently. Referring also to FIGS. 2 and 3, wireless device 300 detects a strong signal event (402). As described above, a strong signal event may indicate the presence of a radar signal within the communication channel. The strong signal event may be in the primary and/or extension segment.

Next, wireless device 300 determines FFT values based, at least in part, on signals received within the primary and the extension segments (404). As described above, wireless device 300 may receive signals (e.g., communication and/or radar signals) within the first frequency segment and the second frequency segment. The first frequency segment may be referred to as the primary segment and the second frequency segment may be referred to as the extension segment. In some embodiments, the first analog processing path P1 may receive the signals associated with the primary segment, and the second analog processing path P2 may receive signals associated with the extension segment. In other embodiments, the first analog processing path P1 may receive signals associated with the extension segment, and the second analog processing path P2 may receive signals associated with the primary segment. In some embodiments, digital processing blocks 232 and/or 234 may determine FFT values based on ADC output data stored in memory 340. FFT values may also be stored in memory 340.

Next, wireless device 300 determines energy associated with the primary segment and the extension segment based, at least in part, on FFT values (406). In some embodiments, wireless device 300 may determine the associated in-band energy from the FFT values (e.g., energy based on the FFT values limited to frequencies used for the communication channel). In other embodiments, wireless device 300 may determine a ratio of in-band energy to out-of-band energy from the FFT values (e.g., a ratio of energy based on the FFT values limited to frequencies used for the communication channel to energy based on the FFT values associated with frequencies above and below the communication channel). For example, digital processing block 232 may receive a frequency band of 160 MHz, while the in-band portion is 80 MHz. FFT values may be computed for the entire 160 MHz frequency band. The wireless device 300 may determine the ratio of in-band energy (energy based on the in-band 80 MHz portion) to out-of-band energy (energy based on frequencies above and below the 80 MHz portion). In some other embodiments, energy associated with the primary segment and the secondary segment may be compared to a threshold. For example, if the energy based on FFT values is less than the threshold, then the wireless device 300 may determine that there is no significant energy associated with the FFT values.

Next, wireless device 300 searches for a radar signal based, at least in part, on the energy determined based on the FFT values and the detected strong signal event (408). Characteristics of the energy associated with the primary and the extension segments together with strong signal event characteristics may be used to direct the search for radar signals. For example, if more energy is associated with the extension segment compared to the primary segment, and a strong signal event is associated with the extension segment, then a radar signal may be more likely to be found within the extension segment. Therefore, wireless device 300 may search for radar signals within the extension segment. This is described in more detail below in conjunction with FIGS. 5A and 5B. In some embodiments, energy characteristics may be normalized with respect to gains that may be applied to signals within the primary and the extension segments. Normalization may help correct energy information and provide a more accurate energy comparison. Searching for radar signals may include pattern matching techniques, time domain and/or frequency domain signal analysis, and any technically feasible radar detection/identification technique.

Next, wireless device 300 determines if another search for radar signals is to be performed (410). For example, in some embodiments, radar searches may be performed periodically or when wireless device 300 operates within a new frequency. If another search for radar signals is not to be performed, then the operation ends. If, on the other hand, another search for radar signals is to be performed, then the operation proceeds to 402.

FIGS. 5A and 5B show an illustrative flow chart depicting another example operation 500 for searching for a radar signal in accordance with some embodiments. First, wireless device 300 determines FFT values based, at least in part, on signals received within the primary and the extension segments (502). Next, the wireless device 300 determines energy associated with the primary segment and the secondary segment based, at least in part, on the FFT values (504). In some embodiments, operations 502 and 504 may be similar to operations 402 and 404 described above in conjunction with FIG. 4.

Next, wireless device 300 determines if a strong signal event is detected within both the primary and the extension segments (506). As described above, a strong signal event may indicate the presence of a radar signal within the communication channel. Since the strong signal event is detected in both the primary and the extension segments, both segments may include the radar signal. If the strong signal event is detected in both the primary and the extension segments, then wireless device 300 determines if more energy is associated with one of the segments (e.g., compared to the other of the segments) (508). Although a strong signal event may be associated with a radar signal, a search for the radar signal may be simplified based, at least in part, on energy associated with a segment. A segment with relatively more associated energy may be more likely to include a radar signal.

Next, if more energy is associated with one of the segments, as tested in 508, then wireless device 300 determines if the segment with more associated energy is within a DFS frequency band (510). As described above, associated energy may be an in-band energy, a ratio of in-band to out-of-band energy or energy greater than a threshold. Depending on the operational mode and configuration of the wireless device 300, the primary segment and/or the extension segment may or may not be within a DFS frequency band. Further, the primary and the extension segments may be non-contiguous and each respective segment may or may not be within a DFS frequency band

If the segment with more associated energy is within a DFS frequency band, as tested in 510, then the wireless device 300 may search for the radar signal within the frequency segment with more associated energy (512). In some embodiments, portions of wireless device 300 not needed to search for the radar signal within the selected segment may transition to a low-power state. For example, if the primary segment is determined to have more associated energy than the extension segment, portions of the digital processing block associated with the extension segment may be placed in a low-power state. Transitioning portions of the wireless device 300 to the low-power state may save power and increase battery life, particularly when wireless device 300 is also a mobile device.

Next, wireless device 300 determines if another search for radar signals is to be performed (FIG. 5B, 514). If another search for radar signals is not to be performed, then the operation ends. If, on the other hand, another search for radar signals is to be performed, then the operation proceeds to 502 (FIG. 5A).

If the segment with more associated energy is not within a DFS frequency band, as tested at 510, then the wireless device 300 stops searching for radar signals (516). Since the segment with more associated energy is not within a DFS frequency band, the wireless device 300 may not be required to vacate the segment if a radar signal (or a received signal that appears to be a radar signal) is detected. The operation proceeds to FIG. 5B, 514.

If wireless device 300 does not determine that more energy is associated with one of the segments, as tested at 508, then wireless device 300 determines if a fallback radar detection mode is enabled (518). A common configuration for wireless devices that operate within or near DFS frequencies is to operate the primary segment within a non-DFS frequency band and operate the extension segment within a DFS frequency band. Thus, for common configurations, radar signals need only be searched for in the extension segment. The fallback radar detection mode provides a “fallback” radar search strategy for times when there is no one segment with more associated energy than another segment, or more energy than a predetermined and/or programmable threshold. For example, fallback radar detection mode may be used when the primary and the extension segments have approximately the same amount of detected energy.

If fallback radar detection mode is enabled, as tested at 518, then the wireless device 300 may search for the radar signal within the extension segment (520). Next, the operation proceeds to FIG. 5B, 514. If, on the other hand, the fallback radar detection mode is not enabled, then the operation proceeds to 516.

If a strong signal event is not detected in both the primary and extension segments, as tested at 506, then wireless device 300 searches for the radar signal within the segment including the strong signal event (522). As described above, the segment with the strong signal event is likely to include the radar signal. Therefore, the segment with the strong signal event is searched for the radar signal. The operation proceeds to FIG. 5B, 514. It is to be noted that, in some embodiments, operations 506-520 may be described partially or wholly by operations 406 and 408 of FIG. 4.

In some embodiments, narrow band signal detection may be used in conjunction with associated energy based on FFT values and strong signal events to search for the radar signal. A narrow band signal may be a radar signal and its presence may be used to guide the search for the radar signal. For example, at 508, in addition to determining if more energy is associated with one of the segments, wireless device 300 may determine if a narrow band signal is also detected within one of the segments. If the narrow band signal is detected within the segment with more associated energy, then the operation proceeds to 510.

In some embodiments, only a portion of a frequency segment may be within a DFS frequency band. Thus, in some cases, a search for the radar signal may be limited to the portion of the frequency segment that is within the DFS frequency band. For example, at 512, 520, and/or 522, the search for the radar signal within the primary and/or extension segments may be limited to portions of the respective segments that are within the DFS frequency band.

In the foregoing specification, the present embodiments have been described with reference to specific exemplary embodiments thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A method of detecting a radar signal by a wireless device, the method comprising:
receiving signals, at the wireless device, within a first frequency segment and a second frequency segment;
determining energy within the first frequency segment and the second frequency segment based, at least in part, on the received signals;
detecting a strong signal event based, at least in part, on the received signals; and
searching for the radar signal based, at least in part, on the determined energy and the strong signal event.

2. The method of claim 1, further comprising:
determining whether more energy is associated with the first frequency segment than is associated with the second frequency segment, wherein the searching for the radar signal is performed within the first frequency segment in response to determining that more energy is associated with the first frequency segment.

3. The method of claim 1, wherein the searching for the radar signal further comprises searching within a frequency segment associated with the strong signal event.

4. The method of claim 1, wherein the searching for the radar signal further comprises:
determining whether a frequency segment associated with more energy corresponds to a dynamic frequency selection (DFS) frequency band; and
searching for the radar signal within the DFS frequency band.

5. The method of claim 1, wherein the first frequency segment and the second frequency segment are non-contiguous.

6. The method of claim 1, wherein the first frequency segment is a primary frequency segment and the second frequency segment is an extension frequency segment.

7. The method of claim 6, further comprising determining whether the wireless device is operating in a fallback radar detection mode.

8. The method of claim 7, wherein searching for the radar signal further comprises searching for the radar signal within the extension frequency segment based, at least in part, on operating the wireless device in the fallback radar detection mode.

9. The method of claim 1, wherein determining the energy within the first frequency segment and the second frequency segment further comprises determining a ratio of in-band energy to out-of-band energy of signals received within the first frequency segment and the second frequency segment.

10. The method of claim 1, further comprising:
determining whether a narrow band signal is received within at least one of the first frequency segment or the second frequency segment or a combination thereof; and
searching for the radar signal based, at least in part, on whether the narrow band signal is received within the at least one of the first frequency segment or the second frequency segment or a combination thereof.

11. The method of claim 1, further comprising:
determining that a portion of the first frequency segment is within a dynamic frequency selection (DFS) frequency band; and
searching for the radar signal within the portion of the first frequency segment that is within the DFS frequency band.

12. A wireless device, comprising:
a transceiver;
a processor; and
a memory storing instructions that, when executed by the processor, cause the wireless device to:
receive signals, at the wireless device, within a first frequency segment and a second frequency segment;
determine energy within the first frequency segment and the second frequency segment based, at least in part, on the received signals;
detect a strong signal event based, at least in part, on the received signals; and
search for a radar signal based, at least in part, on the determined energy and the strong signal event.

13. The device of claim 12, wherein execution of the instructions further cause the wireless device to:
determine whether more energy is associated with the first frequency segment than is associated with the second frequency segment, wherein the search for the radar signal is performed within the first frequency segment in response to determining that more energy is associated with the first frequency segment.

14. The device of claim 12, wherein execution of the instructions further cause the wireless device to:
search for the radar signal within a frequency segment associated with the strong signal event.

15. The device of claim 12, wherein execution of the instructions further cause the wireless device to:
determine whether a frequency segment associated with more energy corresponds to a dynamic frequency selection (DFS) frequency band; and
search for the radar signal within the DFS frequency band.

16. The device of claim 12, wherein the first frequency segment and the second frequency segment are non-contiguous.

17. The device of claim 12, wherein the first frequency segment is a primary frequency segment and the second frequency segment is an extension frequency segment.

18. The device of claim 17, wherein execution of the instructions further causes the wireless device to determine whether the wireless device is operating in a fallback radar detection mode, wherein the search for the radar signal is performed within the extension frequency segment.

19. The device of claim 12, wherein execution of the instructions to determine the energy within the first frequency segment and the second frequency segment further causes the wireless device to determine a ratio of in-band energy to out-of-band energy of signals received within the first frequency segment and the second frequency segment.

20. The device of claim 12, wherein execution of the instructions further causes the wireless device to:
determine whether a narrow band signal is received within at least one of the first frequency segment or the second frequency segment or a combination thereof; and
search for the radar signal based, at least in part, on whether the narrow band signal is received within the at least one of the first frequency segment or the second frequency segment or a combination thereof.

21. The device of claim 12, wherein execution of the instructions further causes the wireless device to:
determine that a portion of the first frequency segment is within a dynamic frequency selection (DFS) frequency band; and
search for the radar signal within the portion of the first frequency segment that is within the DFS frequency band.

22. A non-transitory computer-readable medium storing instructions that, when executed by a processor of a wireless device, causes the wireless device to:
receive signals, at the wireless device, within a first frequency segment and a second frequency segment;
determine energy within the first frequency segment and the second frequency segment based, at least in part, on the received signals;
detect a strong signal event based, at least in part, on the received signals; and
search for a radar signal based, at least in part, on the determined energy and the strong signal event.

23. The non-transitory computer-readable medium of claim 22, wherein execution of the instructions further causes the wireless device to:
determine whether more energy is associated with the first frequency segment than is associated with the second frequency segment, wherein the search for the radar signal is performed within the first frequency segment in response to determining that more energy is associated with the first frequency segment.

24. The non-transitory computer-readable medium of claim 22, wherein execution of the instructions further causes the wireless device to:
search for the radar signal within a frequency segment associated with the strong signal event.

25. The non-transitory computer-readable medium of claim 22, wherein execution of the instructions further causes the wireless device to:
determine whether a frequency segment associated with more energy corresponds to a dynamic frequency selection (DFS) frequency band; and
search for the radar signal within the DFS frequency band.

26. The non-transitory computer-readable medium of claim 22, wherein the first frequency segment and the second frequency segment are non-contiguous.

27. The non-transitory computer-readable medium of claim 22, wherein the first frequency segment is a primary frequency segment and the second frequency segment is an extension frequency segment.

28. The non-transitory computer-readable medium of claim 27, wherein execution of the instructions further causes the wireless device to determine whether the wireless device is operating in a fallback radar detection mode, wherein the search for the radar signal is performed within the extension frequency segment.

29. The non-transitory computer-readable medium of claim 22, wherein execution of the instructions to determine the energy within the first frequency segment and the second frequency segment further causes the wireless device to determine a ratio of in-band energy to out-of-band energy of signals received within the first frequency segment and the second frequency segment.

30. The non-transitory computer-readable medium of claim 22, wherein execution of the instructions further causes the wireless device to:
determine whether a narrow band signal is received within at least one of the first frequency segment or the second frequency segment or a combination thereof; and
search for the radar signal based, at least in part, on whether the narrow band signal is received within the at least one of the first frequency segment or the second frequency segment or a combination thereof.
